(19) United States
(12) Patent Application Publication
(10) Pub. No.: US 2026/0172869 A1
(43) Pub. Date: Jun. 18, 2026

(54) SYSTEMS AND METHODS FOR ALIGNMENT OF QUALITY OF EXPERIENCE FOR AN APPLICATION AND MULTICAST BROADCAST SERVICES

(71) Applicant: Telefonaktiebolaget LM Ericsson (PUBL), Stockholm (SE)

(72) Inventors: Johan Rune, LIDINGÖ (SE); Luca Lunardi, GENOVA (IT); Filip Barac, HUDDINGE (SE); Cecilia Eklöf, TÄBY (SE)

(21) Appl. No.: 19/126,279

(22) PCT Filed: Nov. 3, 2023
(86) PCT No.: PCT/IB2023/061108

§ 371 Date: May 1, 2025

Related U.S. Application Data
(60) Provisional application No. 63/422,589, filed on Nov. 4, 2022.

(51) Int. Cl. H04W 24/10; H04L 41/5067; H04W 4/06

(52) U.S. Cl. CPC H04W 24/10; H04L 41/5067; H04W 4/06

(57) ABSTRACT

A method (700) by a user equipment, UE (112), for an alignment of Quality of Experience, QoE, for service types is provided. According to the method, the UE transmits (702), to a network node (110), a first QoE report for a Multicast and Broadcast Services, MBS, session. The UE transmits (704), to the network node, a second QoE report for an application session running on the MBS session. The first QoE report and the second QoE report are synchronized, associated, aligned, and/or correlated.

### TECHNICAL FIELD

The present disclosure relates, in general, to wireless communications and, more particularly, systems and methods for alignment of Quality of Experience (QoE) for an application and Multicast Broadcast Services (MBS).

### BACKGROUND

Quality of Experience (QoE) measurements, which are also referred to as application layer measurements, have been specified for Long Term Evolution (LTE) and Universal Mobile Telecommunications System (UMTS) and were recently specified for 5^{th} Generation (5G) New Radio (NR) in the 3^{rd} Generation Partnership Project (3GPP) Release 17. The purpose of the QoE measurements is to measure the experience of the end user using certain applications. Currently, the QoE measurements are specified and supported for Dynamic Adaptive Streaming over HTTP (DASH), Mobility Telephony Service for IMS (MTSI), and Virtual Reality (VR).

The solutions in LTE and UMTS are similar. Specifically, QoE Measurement Collection (QMC) enables configuration of application layer measurements in the User Equipment (UE) and transmission of QoE measurement result files, which are commonly referred to as QoE reports, to the network by means of Radio Resource Control (RRC) signalling. An application layer measurement configuration (also called QoE measurement configuration or QoE configuration), which the Radio Access Network (RAN) receives from the Operations & Maintenance (OAM) system, or the Core Network (CN), is encapsulated in a transparent container that is forwarded to a UE in a downlink RRCReconfiguration message. An application layer measurement report (also called QoE report), which the UE Access Stratum (UE AS) or UE RRC layer receives from the UE's higher layer (application layer), is encapsulated in a transparent container and sent to the network in an uplink RRC message, MeasurementAppLayerReport. The RAN then forwards the QoE report to a Measurement Collector Entity (MCE).

In 3GPP, Release 17 “Study on NR QoE management and optimizations for diverse services” with the purpose to study solutions for QoE measurements in NR was finalized and concluded. According to this item, QoE management in NR will not just collect the QoE parameters of streaming services but also consider the typical performance requirements of diverse services (e.g., Augmented Reality (AR)/VR and Ultra-Reliable Low-Latency Communication (URLLC), of which at least VR was covered in 3GPP Release 17). Based on requirements of services, the NR study also included more adaptive QoE management schemes that enable network optimization to satisfy user experience for diverse services.

In standard specifications, the configuration data related to QoE measurements is typically referred to as application layer measurements. This configuration data consists of an indication of a service type, an indication of an area in which the measurements are to be performed (denoted area scope), an IP address of the entity to which the collected measurement results (i.e., the QoE reports) should be sent (often referred to as the MCE), and a set of instructions indicating the type of measurements that should be performed and the details for how these measurements are to be performed. These instructions are intended for the application layer in the UE and are placed in a container that cannot be read and interpreted by the network entities that handle such messages (e.g., forwarding it to the UE, as well as the UE Access Stratum). The currently specified service types are MTSI and streaming service (DASH), and in 3GPP Release 17, VR. An area scope is defined in terms of cells or network related areas. For example, in UMTS, an area scope is defined as either a list of cells, a list of routing areas, or a list of tracking areas. In LTE, an area scope is defined as either a list of cells or a list of tracking areas. In NR, an area scope will be defined as either a list of cells or a list of tracking areas.

QoE, and in particular, the QoE configuration, comes in two flavors: management-based (m-based) QoE configuration and signaling-based (s-based) QoE configuration. In both cases, the QoE configuration originates in the OAM system or some other administrational entity that deals with customer satisfaction. Herein, all of these entities are referred to as the OAM system (where the OAM system also contains further entities).

With the m-based QoE, the OAM system is typically interested in general QoE statistics from a certain area, which is configured as an area scope. The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With the s-based QoE, the OAM system is interested in collecting QoE measurement results from a specific UE because, for example, the user of the UE has filed a complaint. The OAM system sends the s-based QoE configuration to the Home Subscriber Server (HSS) (in Evolved Packet System (EPS)/LTE) or Unified Data Management (UDM) (in the 5th Generation System (5GS)/NR), which forwards the QoE configuration to the UE's current core network node (CN) such as, for example, a Mobility Management Entity (MME) in EPS/LTE or an Access and Mobility Management Function (AMF) in 5G/NR. The CN then forwards the s-based QoE configuration to the RAN node that serves the concerned UE and the RAN forwards it to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace ID is associated with each QoE configuration. In NR, the QoE functionality is logically separated from the Trace functionality, but it will still partly reuse the Trace signaling mechanisms. In NR, and possibly in LTE, a globally unique QoE reference (formed of Mobility Country Code (MCC), Mobile Network Code (MNC), and QoE Measurement Collection Identifier (QMC ID), where the QMC ID is a string of 24 bits) will be associated with each QoE configuration. The QoE reference is included in the container with measurement instructions and also sent to the RAN (i.e., the gNodeB (gNB) in NR). For the communication between the gNB and the UE, the QoE reference is replaced by a shorter identifier denoted as measConfigAppLayerId, which is locally unique within a UE (i.e., there is a one-to-one mapping between a measConfigAppLayerId and a QoE reference for each QoE configuration provided to a UE). The measConfigAppLayerId is stored in the UE AS and also forwarded in an Attention (AT) Command (which is the type of instructions used in the communication between the UE's modem part and the UE's application layer) together with the service type indication and the container with the measurement instructions.

Reports with collected QoE reports are sent from the UE application layer to the UE AS, which forwards them to the RAN, which in turn forwards them to the MCE. These QoE reports are placed in a container, which is uninterpretable for both the UE AS and the RAN. QoE reporting can be configured to be periodic or only to be sent at the end of an application session. Furthermore, the RAN can instruct the UE to pause QoE reporting such as, for example, in case the cell/gNB is in a state of overload.

The RAN is not automatically aware of when an application session with an associated QoE measurement session is ongoing, and the UE AS is also not automatically aware of this. To alleviate this session start/stop indications which are sent from the application layer in the UE to the UE AS and from the UE AS to the RAN were introduced. A session stop indication may be explicit or may be implicit in the form of a QoE report sent when the application session and the associated QoE measurement session are concluded.

The RAN may decide to release a QoE configuration in a UE at any time, as an implementation-based decision. Typically, it is done when the UE has moved outside a configured area scope.

One opportunity provided by previous techniques and solutions is also to be able to keep the QoE measurement for the whole session, even during a handover situation. It is also discussed to let the UE continue with the QoE measurements on an ongoing application session until the application session ends, even if the UE in the meantime moves out of the configured area scope.

### RAN Visible QoE (RVQoE) Measurements

QoE measurements, and their reported results, are intended for analysis in the OAM system (or in other entities that neither belong to the core network nor belong to the RAN) and subsequent possible non-real-time optimizations. The QoE reports are forwarded transparently by the RAN to a configured receiver such as, for example, an MCE. However, the RAN could also benefit from receiving measurement results of metrics measured or collected at the application layer (e.g., as a complement to the more radio related measurements (i.e., the RRM measurements such as, for example, Reference Signal Received Power (RSRP), Reference Signal Received Quality (RSRQ), Signal Interference to Noise Ratio (SINR), . . . )). For instance, the RAN could use such measurement results for real-time or semi-real-time adaptations or optimizations of the treatment of an ongoing application session such as, for example, in terms of scheduling priorities.

For this reason, in Release 17, 3GPP introduced what is called RAN Visible QoE (RVQoE), which comprises periodic reporting of measured application layer metrics in a format that the RAN can understand. in Release 17, the RVQOE metrics are limited to QoE metrics, in particular the Buffer Level QoE metric for DASH (specified in 3GPP TS 26.247 version 17.1.0, which in turn references annex D.4.5 in ISO/IEC 23009-1, and represented in 3GPP TS 38.331 version 17.1.0 (i.e., the RRC specification) as the AppLayer BufferLevel-r17 field) and the Playout Delay for Media Start-up QoE metric for DASH (specified in 3GPP TS 26.247 version 17.1.0 and represented in 3GPP TS 38.331 version 17.1.0 (i.e., the RRC specification) as the playout DelayForMediaStartup-r17 field). In addition to these two RVQoE metrics, a MeasurementReportAppLayer message may contain a PDU session ID list (in the form of the pdu-SessionIdList-r17 field) as part of the reported RVQ information (i.e. in the RAN-VisibleMeasurements-r17 IE).

### The MeasurementReportAppLayer Message

A UE uses the MeasurementReportAppLayer message to report measured QoE metrics and measured RVQoE metrics. It is specified in 3GPP TS 38.331 version 17.1.0.

### Multicast and Broadcast Services (MBS) Overview

Multicast and Broadcast Services (MBS) is a point-to-multipoint service in which services and data are transmitted from a single source entity to multiple recipients, either to all UEs in a Broadcast service area, or to users in a multicast group as defined in 3GPP TS 23.247.

5G NR system enables delivery of MBS in a resource-efficient way. Via the MBS, the same service and the same specific content data from a single source can be provided simultaneously to all UEs in a geographical area (in the broadcast communication service) or to a dedicated set of UEs (in the multicast communication service). That is, all UEs in a broadcast area can receive the data, while not all UEs are authorized to receive the data in a multicast area.

A UE can receive a broadcast MBS communication service independently of its RRC state, while a multicast MBS service can be received only by the UEs in the RRC_CONNECTED state. Multicast communication data can be delivered to a UE via Point-to-Point (PTP) and/or Point-To-Multipoint (PTM) mechanisms, and Hybrid Automatic Repeat request (HARQ) retransmission/feedback can be applied to both of these mechanisms, as specified in 3GPP TS 38.300. FIG. 1 illustrates MBS delivery methods as discussed in 3GPP TS 23.247.

For a multicast communication service, shared and individual delivery modes are specified in 4GPP TS 23.247. Between 5GC and NG-RAN, there are two possible delivery methods to transmit the MBS data:
5GC Individual MBS Traffic Delivery Method: This method is only applied for multicast MBS sessions. 5GC receives a single copy of MBS data packets and delivers separate copies of those MBS data packets to individual UEs via per-UE Packet Data Unit (PDU) sessions, hence for each such UE one PDU session is required to be associated with a Multicast MBS session. The MBS data received by the MB-UPF is replicated towards the UPF(s) where individual delivery is performed via unicast transport over N19mb interface.
5GC Shared MBS Traffic Delivery Method: This method is applied for both broadcast and multicast MBS sessions. 5GC receives a single copy of MBS data packets and delivers a single copy of those MBS packets to an NG-RAN node, which then delivers the packets to one or multiple UEs. These incoming MBS traffic packets are delivered from MB-UPF to NG-RAN node via the N3mb interface.

The 5GC Shared MBS traffic delivery method is required in all MBS deployments. The 5GC Individual MBS traffic delivery method is required to enable mobility when there is an NG-RAN deployment with non-homogeneous support of MBS.

Between the NG-RAN and the UE, two delivery methods are available for the transmission of MBS data packets over radio interface:
Point-To-Point (PTP) Delivery Method: NG-RAN delivers separate copies of MBS data packets over radio interface to individual UE(s).
Point-To-Multipoint (PTM) Delivery Method: NG-RAN delivers a single copy of MBS data packets over radio interface to multiple UEs.

NG-RAN may use a combination of PTP/PTM to deliver an MBS data packets to UEs.

### MBS Radio Bearer

An MBS Session Resource may be associated with one or more MBS QoS flows, and each of those flows is associated with a QoS profile. gNB provides one or more multicast MBS Radio Bearer (MRB) configurations to the UE via RRC signaling, as described in 3GPP TS 38.300, clause 16.10.3. For a multicast session, gNB may change the MRB type using RRC signaling. For a broadcast session, gNB provides a broadcast MRB with one downlink-only Radio Link Control-Unacknowledge Mode (RLC-UM) entity for PTM transmission (i.e., only one type of an MRB is specified at the moment for the broadcast communication transmission). Network and protocol architectures are described in detail in 3GPP TS 38.300 chapters 16.10.2 and 16.10.3.

### Group Scheduling and Group Paging

Group scheduling mechanisms for MBS delivery are described in 3GPP TS 38.300, clause 16.10.4. Radio Network Temporary Identifier (RNTI) is used for the group transmission where a UE can receive different services using the same or different Group-RNTI(s) (G-RNTI(s))/Group Configured Scheduling-RNTI(s) (G-CS-RNTIs), as defined in 3GPP TS 38.300. NG-RAN performs certain functions to support MBS. They include management of MBS Quality of Service (QOS) flows, delivery of MBS data packets from 5GC to multiple UEs via PTP or PTM, configuration of UE for MBS QoS flow reception at AS layer, controlling switching between PTM and PTP delivery per UE, support for multicast session service continuity during Xn and NG handovers, and support for group paging at multicast session activation over radio toward UEs in Connection Management-IDLE (CM-IDLE) state and Connection Management-CONNECTED (CM-CONNECTED) with RRC INACTIVE state.

### MBS Interest Indication

To ensure service continuity of MBS broadcast, the UE in RRC_CONNECTED state may send MBS Interest Indication to the gNB, which may consist of the following information:
1. List of MBS frequencies UE is interested in receiving, sorted in decreasing order of interest;
2. Priority between the reception of all listed MBS frequencies and the reception of any unicast bearer;
3. List of MBS broadcast services the UE is interested in receiving, in case SIB20 is scheduled by the UE's PCell; and/or
4. UE's priority to MBS broadcast versus unicast reception.

MBS Interest Indication information reporting can be implicitly enabled/disabled by the presence of SIB21.

### Mobility Support During MBS Session

Mobility support for service continuation when a UE is in an MBS session depends on whether the broadcast or multicast session is taking place, and on whether the source and target nodes support MBS. For the multicast MBS session, three cases can be distinguished: 1) handover from an NG-RAN node supporting MBS to a node not supporting MBS, 2) handover from an NG-RAN node not supporting MBS to a node supporting MBS, and 3) a handover from a node supporting MBS to another node supporting MBS.
In the Multicast MBS case:
   When the HO takes place from a node that supports MBS to a node that does not support MBS, or vice versa, the 5GC Shared MBS Traffic Delivery and 5GC Individual Traffic delivery methods can co-exist temporarily upon handover.
      Mapping information about unicast QoS flows for multicast data transmission and the information of associated multicast QoS flows are provided to an NG-RAN node.
      The delivery method is switched from 5GC Shared MBS Traffic delivery to 5GC Individual MBS delivery via establishing the N3 tunnel of the PDU Session for Individual delivery. Session Management Function (SMF) realizes that the target node does not support MBS.
      General Packet Radio Service Tunneling Protocol (GTP) tunnel between the UPF and the MB-UPF for 5GC Individual MBS traffic delivery is activated by SMF and MBS-SMF
When the HO takes place from a RAN node that supports MBS to another node that also supports MBS, if the shared delivery for the MBS session has not been established towards the target NG-RAN node, it uses Multicast Broadcast Session Management Function (MB-SMF) and Multicast Broadcast User Place Function (MB-UPF) to establish the shared delivery for the MBS session.
   The PDU Sessions, including the one associated with the MBS Multicast session and used for the 5GC Individual MBS traffic delivery, are handed over to the target NG-RAN node.
      SMF triggers the mode switch from the Individual to the Shared delivery mode.
      Target node establishes the shared delivery for the MBS Session upon receiving the MBS Session Context.
      5GC Individual MBS traffic delivery is terminated by 5GC and changed to the 5GC shared MBS traffic delivery.
In the Broadcast MBS case:
   The UE may receive the same service in the target node (which supports MBS) if the same MBS session is established with the 5GC Shared MBS traffic delivery.
   Currently, a case of when a UE is handed over to a node not supporting the MBS within the broadcast area, is not specified.

### QoE Metrics for Multimedia Broadcast Multicast Service (MBMS)

The 3GPP TS 26.346 version 17.1.0 defines QoE metrics for the Multimedia Broadcast Multicast Service (MBMS), in addition to QoE metrics for DASH streaming that can also be used. The full table from TS 26.346 version 17.1.0 is presented below as Table 1 for reference.

TABLE 1

| | Streaming | Download | |
|---|---|---|---|
| | delivery | delivery | Metric |
| QoE Metric | method | method | type |
| Corruption duration metric | ✓ | | Media |
| Rebuffering duration metric | ✓ | | Session |
| Initial buffering duration metric | ✓ | | Session |
| Successive loss of RTP packets | ✓ | | Media |
| Frame rate deviation | ✓ | | Media |
| Jitter duration | ✓ | | Media |
| Content Access/Switch Time | ✓ | | Session |
| Network Resource | ✓ | ✓ | Session |
| Average codec bitrate | ✓ | | Media |
| Codec information | ✓ | | Media |
| Loss of Objects | | ✓ | Session |
| Distribution of Symbol Count | | ✓ | Session |
| Underrun for Failed Blocks | | | |

### 3GPP Release 18 QoE Work Item

For 3GPP Release 18, the RP-221803 describes the Work Item “Enhancement on NR QoE management and optimizations for diverse services” and among others, it indicates, the following objectives:
Support for new service type, such as AR, MR, MBS and other new service type defined or to be supported by SA4. Support RAN-visible parameters for the additional service types, and the existing service if needed, and the coordination with SA4 is needed [RAN3, RAN2].
   Specify the new service and the existing service defined or to be supported by SA4, combined with high mobility scenarios, e.g., High Speed Trains.
Specify for QoE measurement configuration and collection in RRC_INACTIVE and RRC_IDLE states for MBS, at least for broadcast service [RAN3, RAN2].
   Specify the mechanism to support the alignment of the existing radio related measurement and QoE reporting.
Left-over features from Release 17, as well as the enhancements of existing features which are not included in Release 17 normative phase, should be supported in Release 18 if consensus on benefits are reached [RAN3, RAN2].
   Specify per-slice QoE measurement configuration enhancement.
   Specify RAN visible QoE enhancements for QoE value, RAN visible QoE trigger event, RAN visible QoE Report over F1.
   Specify QoE reporting handling enhancement for overload scenario

### SUMMARY

There currently exist certain challenge(s). For example, the LTE approach of including application related QoE metrics in the MBMS QoE report, as described above, may not be suitable for NR, and it would therefore be better to not reuse it for MBS in NR. One reason is that sessions for multiple kinds of applications potentially may be carried over MBS. Hence, a more future-proof approach may be to make the MBS QoE measurement configuration independent (e.g., separate) of the QoE measurement configuration for the application that is carried by the MBS session. This would result in an MBS QoE configuration which focuses on MBS-specific metrics, which is separate from a possible QoE configuration for an application whose session data is carried by MBS. QoE measurements may also be performed on the application session whose data is carried over MBS, where such QoE measurements may be configured and reported as described in the 3GPP Release 17 specifications (although additions related to MBS are not excluded).

A problem arising from this approach is that, because of the separate QoE reports for MBS and application sessions, the entity analyzing the QoE reports lacks means of determining how certain values or changes of MBS properties (such as delivery mode) and/or changes of an MBS specific QoE metric affects the QoE of the application session.

Certain aspects of the disclosure and their embodiments may provide solutions to these or other challenges. For example, methods and systems are provided for enabling synchronization, alignment, association and/or correlation between a QoE report for an MBS session and a QoE report pertaining to an application session whose data was carried by the MBS session.

According to certain embodiments, a method by a UE for an alignment of QoE for service types includes transmitting, to a network node, a first QoE report for a MBS session. The UE transmits, to the network node, a second QoE report for an application session running on the MBS session. The first QoE report and the second QoE report are synchronized, associated, aligned, and/or correlated.

According to certain embodiments, a UE for an alignment of QoE for service types is adapted to transmit, to a network node, a first QoE report for a MBS session. The UE is adapted to transmit, to the network node, a second QoE report for an application session running on the MBS session. The first QoE report and the second QoE report are synchronized, associated, aligned, and/or correlated.

According to certain embodiments, a method by a network node for an alignment of QoE for service types includes receiving, from a UE, a first QoE report for a MBS session. The UE receives, from the UE, a second QoE report for an application session running on the MBS session. The first QoE report and the second QoE report are synchronized, associated, aligned, and/or correlated.

According to certain embodiments, a network node for an alignment of QoE for service types includes receiving, from a UE, a first QoE report for an MBS session. The network node receives, from the UE, a second QoE report for an application session running on the MBS session. The first QoE report and the second QoE report are synchronized, associated, aligned, and/or correlated.

Certain embodiments may provide one or more of the following technical advantage(s). For example, certain embodiments may provide a technical advantage of enabling an entity analyzing the QoE report associated with an application session and the QoE report for an MBS session to determine how the properties of MBS transmissions, e.g. as reflected by the QoE measurements on an MBS session, impact the quality experienced at an application whose session data is carried by MBS, i.e. as reflected by the QoE measurements on the application session.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates MBS delivery methods as discussed in 3GPP TS 23.247;

FIG. 2 illustrates an example communication system, according to certain embodiments;

FIG. 3 illustrates an example UE, according to certain embodiments;

FIG. 4 illustrates an example network node, according to certain embodiments;

FIG. 5 illustrates a block diagram of a host, according to certain embodiments;

FIG. 6 illustrates a virtualization environment in which functions implemented by some embodiments may be virtualized, according to certain embodiments;

FIG. 7 illustrates a host communicating via a network node with a UE over a partially wireless connection, according to certain embodiments;

FIG. 8 illustrates a method by a UE for an alignment of QoE for service types, according to certain embodiments; and

FIG. 9 illustrates a method by a network node for an alignment of QoE for service types, according to certain embodiments.

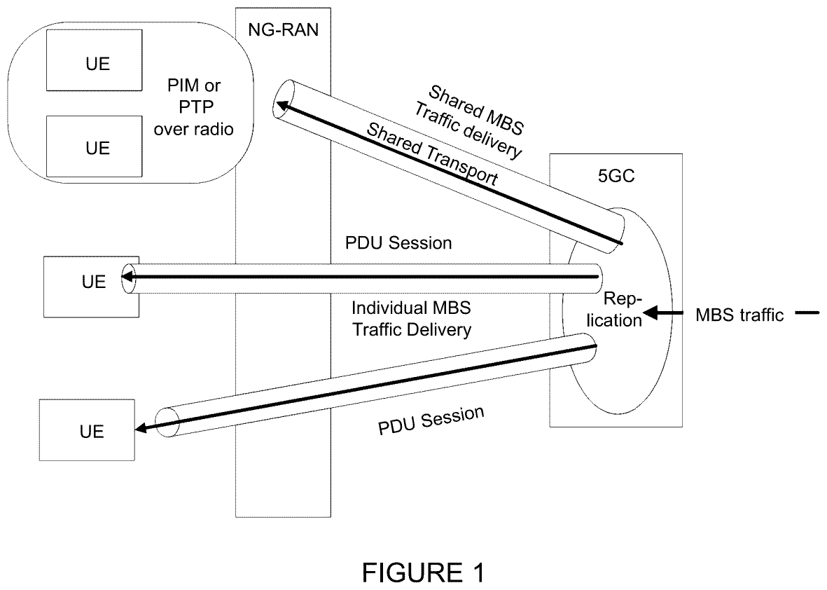

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g., Mobile Switching Center (MSC), Mobility Management Entity (MME), etc.), Operations & Maintenance (OAM), Operations Support System (OSS), Self Organizing Network (SON), positioning node (e.g., E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, Machine Type Communication UE (MTC UE) or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, ‘radio network node’ or simply ‘network node (NW node)’, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

The terms ‘application layer measurement configuration’, ‘application measurement configuration’, ‘QoE measurement configuration’, ‘QoE configuration’, ‘QoE measurement and reporting configuration’ and ‘QMC configuration’ are used interchangeably. But note that the ‘QMC configuration file’ is not an equivalent term, but instead refers to the part of the QoE configuration consisting of an XML file containing instructions of QoE metrics to be collected etc.

For short notation, where not stated otherwise, the terms ‘QoE measurement configuration’ and ‘QoE-configuration items’ can refer to both QoE (or legacy QoE, or OAM-QoE, whose measurements are not visible to RAN, and RAN Visible QoE.

The terms ‘QoE report’ and ‘QoE measurement report’ are used interchangeably. Similarly, the terms ‘RAN Visible QoE report’, ‘RAN Visible QoE measurement report’, ‘RVQoE report’ and ‘RVQoE measurement report’ are used interchangeably.

The terms ‘access stratum’ and ‘radio layer’ are used interchangeably when referring to a UE.

The terms ‘service type’ and ‘application layer service type’ are used interchangeably.

The term ‘session’ is used herein to refer to either a QoE measurement session or an application session or an application session for which QoE measurement is applied.

The term ‘session’ is used herein to refer to either a QoE measurement session or an application session or an application session for which QoE measurement is applied.

The solution proposed in this invention applies to UMTS, LTE and NR as well as future RATs such as 6G.

Unless otherwise stated, all considerations in this solution description equally apply to both QoE and RVQoE measurements.

As used herein, ‘MBS QoE configuration’ refers to ‘QoE configuration for MBS’ (e.g., QoE configuration with service type indicating MBS) (i.e., they are considered to be equivalent terms/expressions), and ‘MBS QoE measurement’ refers to ‘QoE measurement on MBS’ (measuring/collecting MBS related QoE metrics) (i.e., they are considered to be equivalent terms/expressions), and ‘MBS QoE report’ refers to ‘QoE report for MBS’ or ‘QoE report for QoE measurements performed on MBS’ (i.e., they are considered to be equivalent terms/expressions). Similarly, ‘application QoE configuration’ refers to ‘QoE configuration for an/the application’ (e.g., QoE configuration with service type indicating the service type of the application) (i.e., they are considered to be equivalent terms/expressions), and ‘application QoE measurement’ refers to ‘QoE measurement on an/the application’ (measuring/collecting QoE metrics associated with the application's service type) (i.e., they are considered to be equivalent terms/expressions), and ‘application QoE report’ refers to ‘QoE report for an/the application’ or ‘QoE report for QoE measurements performed on an/the application’ or ‘QoE report for an/the application session’ or ‘QoE report for QoE measurements performed on an/the application session’ (i.e., they are considered to be equivalent terms/expressions).

According to certain embodiments, MBS is defined as a service type in the context of QoE, and QoE measurements for MBS are configured in their own separate configuration, and the QoE measurement results are compiled in their own reports. In parallel, there may be QoE measurements configured, and QoE reports compiled, for an application (of another service type, such as “streaming”) running on MBS (i.e., whose session data at least partly is conveyed by MBS). Unless otherwise stated, when the description and embodiments refer to an application or an application session, it is assumed that this is an application or applications session whose session data at least partly is conveyed via MBS.

To facilitate analysis of how the properties of MBS transmissions, e.g., as reflected by the QoE measurements on an MBS session, impact the quality experienced at an application whose session data is carried by MBS, i.e. as reflected by the QoE measurements on the application session, the application QoE measurement session and the MBS QoE measurement session should be aligned and there should be some association between the respective QoE reports. More specifically, when an application is running on MBS, it would be beneficial if an analyzing entity could analyze, identify or determine how the properties of the MBS transmissions, e.g., as reflected by the QoE measurements on an MBS session, impact the quality experienced at the application, i.e. as reflected by the QoE measurements on the application session. To facilitate this, the QoE measurements on the MBS session and the QoE measurements on the application session should be aligned and there should be some association between the respective QoE reports.

According to certain embodiments, methods and systems are provided for enabling synchronization, alignment, association and/or correlation between a QoE report for an MBS session and a QoE report pertaining to an application session whose data was carried by the MBS session. According to certain particular embodiments, the mechanisms for the alignment consist of application QoE measurement session start and stop indications (triggering MBS QoE measurements or compiling of MBS QoE report(s)) and/or timestamps inside or associated with the QoE reports. According to certain particular embodiments, the mechanisms for the association consist of cross reference(s) between the QoE reports and/or inclusion of the QoE reports in the same message (with or without an explicit indication of the association).

### Embodiments for Alignment of MBS QoE Measurements and Application QoE Measurements

According to certain embodiments, to align the MBS QoE measurements and the application QoE measurements, the respective QoE measurement sessions are started and stopped in a aligned, coordinated, and/or synchronized manner. Alternatively, if the start and stop of the measurement sessions are not aligned, coordinated, and/or synchronized, the reported MBS QoE measurement results and the reported application QoE measurement results are correlated such as, for example, by using time information such as, for example, timestamps in the respective QoE reports. The alignment, correlation, and/or synchronization could be achieved in several ways, as described below.

### Alignment Using QoE Measurement Session Start and Stop Indications

In a particular embodiment, the MBS QoE measurements start when the application QoE measurement session starts. In a particular embodiment, for example, this can be enabled by letting the application generate an indication when an application session, for which QoE measurements are configured, starts, and a corresponding indication when the concerned session stops.

In a particular embodiment, such indications are conveyed between the application and an MBS entity at the application layer. Alternatively, in other particular embodiments, the indications are conveyed from the application to an MBS entity in the UE AS (or another layer below the application layer or another entity outside the application layer). In another particular embodiment, the application sends the indications to the UE AS (e.g., using AT commands) and the UE AS forwards them to an MBS entity, wherein this MBS entity may reside at the application layer, in the UE AS, or in a UE unit that belongs neither to the application layer nor to the UE AS.

In a particular embodiment, the start and stop indications may be the session start and session stop indications generated by applications (if configured to do so) and sent to the UE AS in the form of the <qoe_measurement_status>parameter in the +CAPPLEVMRNR AT command.

There are potential scenarios where the application session and its associated QoE measurement session are not started simultaneously, but instead the application QoE measurement session is started when the application session is already running (e.g., if the UE receives the QoE measurement configuration for the application while an application session is running). In such scenarios, the start indication is generated when the application QoE measurement session starts. Thus, in a particular embodiment, the start and stop indications indicate the start and stop of the application QoE measurement session.

According to certain other embodiments, another alternative is that the start indication (and optionally also the stop indication) is sent all the way to the RAN (e.g., gNB or eNB), and upon receiving such a start indication, the RAN sends a pending MBS QoE configuration to the UE and, thereby, configured MBS QoE measurements are started in the UE immediately. Alternatively, an MBS QoE configuration may be sent to the UE first, while the QoE configuration is pending at the RAN. Upon receiving a start indication, the RAN sends the application session-related QoE configuration to the UE, in a particular embodiment.

The QoE configurations for which the QoE measurement session start indications should trigger the RAN to send the MBS QoE configuration to the UE may be configured in the RAN such as, for example, via an instruction conveyed together with the MBS QoE configuration and/or together with the application QoE configuration(s) with which the configured application QoE measurements the MBS QoE measurements should be aligned.

Alternatively, in a particular embodiment, the RAN is configured with, or it may be specified in a standard specification, which service types whose QoE measurement session start indications should trigger the RAN to send the MBS QoE configuration. In a particular embodiment, the RAN receives an indication together with the MBS QoE configuration indicating that the MBS QoE measurements configured by the MBS QoE configuration should be aligned with an application QoE measurement session associated with an application of either of a set (one or more) of service types, where the set of service types is explicitly conveyed together with or as a part of the alignment instruction associated with the MBS QoE configuration, or alternatively, the set of service types is specified in a standard specification.

In a further particular embodiment, pertaining to the case when the MBS QoE configuration pertains to multiple (a set of) service types, whenever a session pertaining to a service from the indicated set of service types is started, an instance of the MBS QoE configuration is created, and MBS QoE measurement is initiated. To differentiate between different instances of the MBS QoE configuration (where each instance has been activated for a different service type), an additional indicator (e.g., MBS QoE configuration instance identifier or QoE sub-reference) is assigned to each instance and reported inside the corresponding MBS QoE report. For example, if the MBS QoE configuration lists a set of 5 different service types that may be carried via MBS, and if, for each service type, one session is started, there will be 5 active instances of MBS QoE configuration. Each will have a configuration identifier (i.e., the same as the identifier of the original MBS QoE configuration), and a unique instance identifier.

In a further particular embodiment, the MBS QoE configuration may pertain to several applications (that may or may not pertain to the same service type).

It may be noted that the above is similar to the method used for alignment of QoE measurements and MDT measurements. Thus, in various particular embodiments, the same start and stop indications may be used as described above. For example, the start and stop indications may be conveyed from the UE application layer to the UE AS, and conveyed from the UE AS to the RAN in the form of the appLayerSessionStatus-r17 field in the MeasurementReportAppLayer RRC message in NR, in a particular embodiment.

In another potential scenario, the start and stop of the MBS QoE measurements may not be synchronized with the application session and its associated QoE measurement session. Instead, the MBS QoE measurements may already be ongoing when the application session and the associated QoE measurement session starts and may also continue after the application session and its associated QoE measurement session have ended. Then, the above-described start and stop indications (for the QoE measurement session associated with the application session) may be leveraged to compile an MBS QoE report comprising the MBS QoE measurement results collected during the time period the application QoE measurement session was running (i.e., during the time between the start and stop indications).

### Alignment Using Timestamps

In particular embodiments, where the QoE measurement session may start before the application QoE measurement session associated with the application session and may end after the application QoE measurement session associated with the application session, timestamps may be utilized in the respective QoE reports (i.e., the MBS QoE report and the application QoE report) to enable alignment, correlation, and/or synchronization between the reported MBS QoE measurement results and the reported application QoE measurement results.

To this end, timestamps may be associated with various items (e.g., metrics or events) included in the reports. Optionally, in a particular embodiment, the content of the report may be organized such that it follows a timeline, where the timeline is realized in the form of the timestamps. In another particular embodiment, timestamps are included only to indicate the start and stop of the QoE measurements reported in the respective QoE measurement reports.

In yet another particular embodiment, the timestamps only indicate the starts of the respective QoE measurement sessions (i.e., the MBS QoE measurement session and the application QoE measurement session).

In a particular embodiment, as an alternative to including the timestamps (for the start times of the reported QoE measurements or for the start and end times of the reported QoE measurements) in the QoE reports, the timestamps are conveyed to the MCE together with—and associated with—the respective QoE report. Thus, the timestamps are not inside the QoE reports. In a particular embodiment, for example, the timestamps are generated by the application and the MBS entity (and conveyed via the UE AS and the RAN to the MCE). In another particular embodiment, the timestamps are generated by the UE AS (and conveyed via the RAN to the MCE). In still another particular embodiment, the timestamps are generated by the RAN (e.g., the gNB or eNB).

The timestamps may also be combined with any of the methods using QoE measurement session start and stop indications described herein.

### Alignment Using New Indications

According to certain other embodiments, alignment is performed in the application layer and the UE AS may notify the application layer when MBS is used. A new indication may be sent from the UE AS to the application layer when MBS is used as communication service for a certain service type. There is a mapping between the bearer and the QoS flow carrying the service type and when MBS is used as the communication service for the bearer mapped to the QoS flow carrying the service type, the AS layer notifies the application layer of this. The application layer then starts both the MBS QoE measurements and the application QoE measurement when the application session, for which QoE measurements are configured, starts. The indication of MBS may be sent to the application layer together with other information such as, for example, an identification of the QoE measurement such as, for example, the measConfigAppLayerId.

In a particular embodiment, there is also an indication to the application layer when MBS is no longer used as the communication service (i.e., a notification of the end of MBS).

The new indication may be combined with the session start and session end indications so that the UE AS layer only sends the indication of MBS when it has been notified by the application layer that the session for which there are application QoE measurements configured has been started. Else, as an alternative, the UE AS layer sends a notification of MBS as soon as MBS is configured.

### Alignment Using Triggering Conditions

According to certain additional or alternative embodiments, the alignment can be achieved by configuring the same triggering condition for QoE and MBS QoE measurements, resulting in simultaneous initiation of both measurements.

In a particular embodiment, the MBS QoE configuration may be configured with a measurement trigger, while the corresponding measurement trigger contained in the QoE configuration may be “start the measurement when receiving a trigger from the MBS QoE entity”. In another embodiment, the opposite is true.

In a particular embodiment, the trigger may pertain to (meaning that its fulfillment may be detected by) the UE AS layer, which then indicates simultaneously to the application layer and MBS entity at the UE that the measurements should start.

In another particular embodiment, the trigger is detected by another entity at the UE application layer such as, for example, an entity coordinating QoE aspects. After detecting fulfillment of a trigger condition, the entity indicates simultaneously to the application layer and MBS entity at the UE that the measurements should start, in a particular embodiment.

### Association of MBS QoE Reports and Application QoE Reports

In particular embodiments, in addition to the alignment/correlation of the MBS QoE measurements and the application QoE measurements, it is beneficial if the generated MBS QoE report and application QoE report are associated with each other. Different ways to achieve this are described as different embodiments below.

### References for Associating MBS QoE Reports and Application QoE Reports

According to certain particular embodiments, the association between an application QoE report and an MBS QoE report is achieved by including cross-references in the QoE reports. That is, in the MBS QoE report there is a reference to the application QoE report, and/or in the application QoE report there is a reference to the MBS QoE report. In a particular embodiment, for example, the MBS QoE report contains a reference to the application QoE report, but there is no reference in the application QoE report. In another particular embodiment, the application QoE report contains a reference to the MBS QoE report, but there is no reference in the MBS QoE report.

In another particular embodiment, instead of including a reference in a QoE report, the reference is associated with the QoE report and transmitted together with the QoE report, but it is not included in the QoE report. For example, the reference to the application QoE report may be associated with, and transmitted together with, the MBS QoE report, and/or the reference to the MBS QoE report may be associated with, and transmitted together with, the application QoE report.

In various embodiments, the reference could have different forms and still serve its purpose. A few of options are:
A QoE reference: As described herein, a QE reference is a globally unique identifier formed of MCC+MNC+QMC ID, where the QMC ID is a string of 24 bits. A QoE reference identifies a QoE measurement configuration.
   In absence of a complementing Recording Session ID, timestamps may be used to allow an entity analyzing QoE reports and/or forwarding QoE reports to identify the specific QoE report(s) to correlate with one or more other QoE report(s).
   In 3GPP Release 17, the QoE reference is not sent to the UE AS. It is only included in the QMC configuration file which is passed on to the UE's application layer. Instead of the QoE reference, a shorter identifier denoted as measConfigAppLayerId (or measConfigAppLayerId-r17) is used in the RRC signaling between the RAN (gNB) and the UE AS in NR. Thus, if the UE AS is to send a QoE reference to the RAN together with an MBS QoE report or an application QoE report, the UE AS has to have access to the concerned QoE reference. To this end, in a particular embodiment, the UE AS receives the QoE reference from the application layer such as, for example, together with a QoE measurement report in a +CAPPLEVMRNR AT command, or in a response to a +CAPPLEVMCNR AT command delivering a QoE measurement configuration to the UE's application layer. Alternatively, in another embodiment, the UE AS receives the QoE reference from the RAN (e.g., a gNB or an eNB) such as, for example, in an AppLayerMeasConfig IE in an RRCReconfiguration message.
A QoE reference combined with a Recording Session ID: A Recording Session ID is an identifier generated by the UE, which identifies a specific QoE measurement session, where a QoE measurement session collects/measures metrics pertaining to a certain application session.
   A QoE measurement report can contain QoE measurement results from only one QoE measurement session (i.e., all or a subset of the QoE measurement results collected during a QoE measurement session). Since all QoE measurement reports generated in accordance with the same QoE measurement configuration will contain the same QoE reference, the QoE reference is complemented with a Recording Session ID in a particular embodiment so as to reference the QoE measurement report(s) generated from a certain QoE measurement session.
A measConfigAppLayerId (also referred to as measConfigAppLayerId-r17): A measConfigAppLayerId is an identifier that is locally unique in a UE and has a one-to-one mapping to a QoE measurement configuration in the UE. The purpose of the short measConfigAppLayerId is to replace the longer QoE reference in the control signaling over the radio interface in order to reduce the control signaling overhead.
   A problem with using the measConfigAppLayerId as a reference is that, since it is generated by the RAN and unique only within a single UE, it is not understood or usable by the MCE or any other RAN external entity. Thus, if a measConfigAppLayerId is to be used as a reference, it would have to be replaced with the QoE reference by the RAN. For example, in a particular embodiment, a reference in the form of a measConfigAppLayerId is sent together with a QoE report from the UE's application layer to the UE AS and further to the RAN in a MeasurementReportAppLayer RRC message. In the case where the UE AS is to generate the reference, and the reference has the form of a measConfigAppLayerId, it is sent together with the QoE report to the RAN in a MeasurementReportAppLayer RRC message, in a particular embodiment. When the RAN has received a reference in the form of a measConfigAppLayerId together with a QoE report in a MeasurementReportAppLayer RRC message, the RAN translates the received measConfigAppLayerId into the QoE reference it maps to before sending this QoE reference together with the QoE report to the MCE.
A measConfigAppLayerId (also referred to as measConfigAppLayerId-r17) combined with a Recording Session ID:
   The same considerations apply regarding the MCE's (and other RAN external entities') inability to understand the measConfigAppLayerId and the local uniqueness of the measConfigAppLayerId, as described above. In particular embodiments, the Recording session ID is inside the QoE report or sent together with it, or both.
The same measConfigAppLayerId may be used for the application QoE report and the MBS QoE report. The same measConfigAppLayerId indicates that the reports are associated.
A new type of identifier used for correlation of QoE measurements and/or QoE measurement reports: It could be included in the QoE report or sent together with the QoE report, or both.
A special type of QoE reference, i.e. a QoE reference for MBS: In one alternative embodiment, the entity configuring the QoE job (e.g., OAM) can a priori indicate that a given set of the QMC ID string of 24 bits are reserved for application data carried over MBS. In another alternative embodiment, an extended version of the QoE reference presently defined is introduced, wherein a suffix or a prefix (or a suffix and a prefix) is (are) associated to MBS (i.e., used to indicate that application session targeted by the QoE job can—at least potentially—be carried over MBS).
   In a further particular embodiment, the QoE reference for MBS is added in (or to) the QoE measurement reports for the application as well as in (or to) the QoE measurement reports for MBS to indicate an explicit alignment/correlation of the reports.
   In another particular embodiment, a QoE reference for MBS including a suffix and/or a prefix associated to MBS, is added only in/to the QoE measurement reports for MBS and not in/to the QoE measurement reports for the application, and the alignment/correlation is achieved comparing the QoE reference for the QoE measurement reports for MBS and the QoE reference for the QoE measurement reports for the application. For instance, in a particular embodiment, the entity receiving the QoE reports (such as an MCE, or some other entity northbound) extrapolates the suffix and/or the prefix of the QoE reference for MBS and determines that the received QoE measurements pertains to MBS, and determines that alignment/correlation between the two QoE reports is needed, provided that the QoE reference for the QoE report of the application coincides with the QoE reference for MBS except for the prefix and/or suffix associated to MBS.
      For example, the QoE reference for MBS may be “001110011” concatenated with “11”, where the last two bits to indicate “MBS”. The QoE reference for application is “001110011”. An MCE receives QoE reports for MBS and QoE reports for the application. In this example, the MCE reads the last two bits “11” and determines that the QoE report is for MBS. Then, the MCE compares the remaining bits of the QoE reference for MBS with the QoE reference indicated in the QoE report for the application and realizes that the two QoE reports are to be aligned/correlated.
   In another particular embodiment, similar to the above, the QoE reference for MBS includes a suffix and/or a prefix associated to a service delivery method, where a service delivery method can be one of “Multicast”, “Broadcast”.
   In another particular embodiment, the QoE reference for MBS includes an explicit indication of service type.
   In another particular embodiment, such as in the case where several instances of MBS QoE configuration are created, the reference to the MBS QoE configuration contains the instance identifier.

In particular embodiments, such a reference is part of the QoE framework and, thus, identifies or refers to QoE concepts, such as a QoE measurement session, a QoE measurement report, a set of QoE measurement reports generated from the same QoE measurement session, a QoE measurement session whose generated QoE measurement results are included in one or more specific QoE measurement reports, and/or a QoE measurement configuration.

Various methods may be used to enable an application and an MBS client/entity to exchange parameters that can be used as references. As one option, when an application invokes the MBS client/entity, or associates with it, the MBS client/entity can, unsolicited or on request from the application, inform the application of the reference parameter(s) (e.g., QoE reference and Recording session ID) of any MBS QoE configuration and/or QoE measurement session that it has and/or the application can inform the MBS client of the reference parameter(s) (e.g., QoE reference and Recording session ID) of any QoE configuration and/or QoE measurement session that the application has. Another, possibly complementing, option is that the application requests the MBS client/entity to generate a QoE report for the time from when the application starts using MBS such as, for example, the time of the request (i.e., when the application invokes or associates with the MBS client/entity) until the application's session and/or its associated QoE measurement session, ends and the application stops using MBS (at least for the time being). This may require that the application notifies the MBS client when it has stopped receiving the data carried over MBS and/or when the application QoE measurement session has ended. An alternative to such a session end (and/or end of MBS usage) notification from the application to the MBS client/entity could be that the MBS client keeps the QoE measurements running during the entire or remainder of the MBS session from the MBS client's/entity's point of view, which may be a longer time such as, for example, from the UE's join MBS operation until the leave MBS operation or until the MBS transmissions cease (i.e., when the MBS session, as seen from the network's point of view, ends). Then, timestamps in the respective QoE reports, or associated with the respective QoE reports, are used to facilitate the correlation during the analysis of the QoE reports, in particular embodiments.

Another option is that a coordinating entity such as, for example, an entity residing at the application layer, acts as a mediator between the application and the MBS client/entity. In a particular embodiment, this coordinating entity detects the need for exchange of parameter(s) to be used as reference(s) and passes the reference parameter(s) from the MBS client/entity to the application and/or from the application to the MBS client/entity. Another option is that the application informs the coordinating entity of the need for transfer of reference parameter(s) and requests the coordinating entity to perform it, and the coordinating entity then performs the requested transfer of reference parameter(s) from the MBS client/entity to the application and/or from the application to the MBS client/entity.

Another possibility is that the UE AS, after having received instructions from the RAN about the alignment/correlation to be performed, keeps track of QoE reports generated by the application and the MBS entity, and the reference parameter(s) (e.g. QoE reference and Recording session ID) of one of the QoE reports is associated as a reference with the other QoE report and sent together with it. This way, the UE AS creates an associated reference from the application QoE report to the MBS QoE report and/or from the MBS QoE report to the application QoE report.

### a Common Message Used to Associate MBS QoE Reports and Application QoE Reports

According to certain particular embodiments, the association between an application QoE report and an MBS QoE report is achieved by transferring the two QoE reports in the same message. For example, in a particular embodiment, inclusion of the two QoE reports in the same MeasurementReportAppLayer message is an implicit indication that the two QoE reports are associated and are correlated with each other. Similarly, inclusion of the two QoE reports in the same +CAPPLEVMRNR AT command or the same +CAPPLEVMR AT command is an implicit indication that the two QoE reports are associated and are correlated with each other. This could be expressed as a rule stating that if two QoE reports are included in the same MeasurementReportAppLayer message or in the same +CAPPLEVMRNR AT command or in the same +CAPPLEVMR AT command, and one of the two QoE reports, but not both, is an MBS QoE report, then the two QoE reports are associated and are correlated with each other. A variation of this rule could be that if two QoE reports are included in the same MeasurementReportAppLayer message or in the same +CAPPLEVMRNR AT command or in the same +CAPPLEVMR AT command, and one of the two QoE reports is an MBS QoE report while the other is a QoE report associated with a session of an application which may run over MBS, then the two QoE reports are associated and are correlated with each other.

As another option, in a particular embodiment, a message containing an MBS QoE report and an application QoE report which are aligned and are associated with each other could include an explicit indication of this. To this end, in a particular embodiment, the application layer includes an alignment or association indication in the AT command(s) conveying the QoE reports for the MBS and application sessions to the UE AS. Similarly, in a particular embodiment, the UE AS includes an explicit alignment or association indication in a MeasurementReportAppLayer RRC message including an MBS QoE report and an application QoE report that are aligned and are correlated with each other. When the RAN subsequently forwards the application QoE report and the MBS QoE report to the MCE, the RAN also—implicitly or explicitly—indicates the correlation, association, synchronization, and/or alignment between the QoE reports.

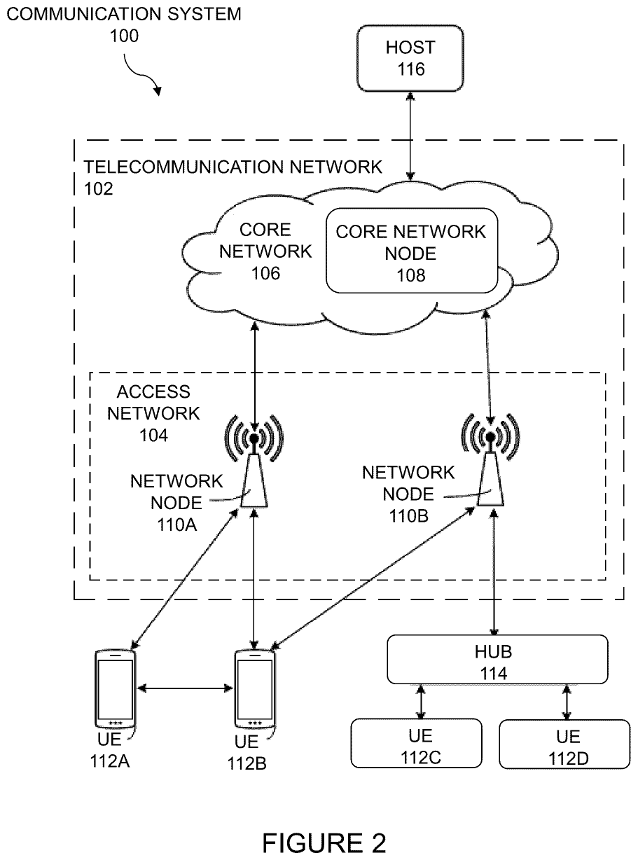

FIG. 2 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), HSS, AMF, Session Management Function (SMF), Authentication Server Function (AUSF), Subscription Identifier De-concealing function (SIDF), UDM, Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 2 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

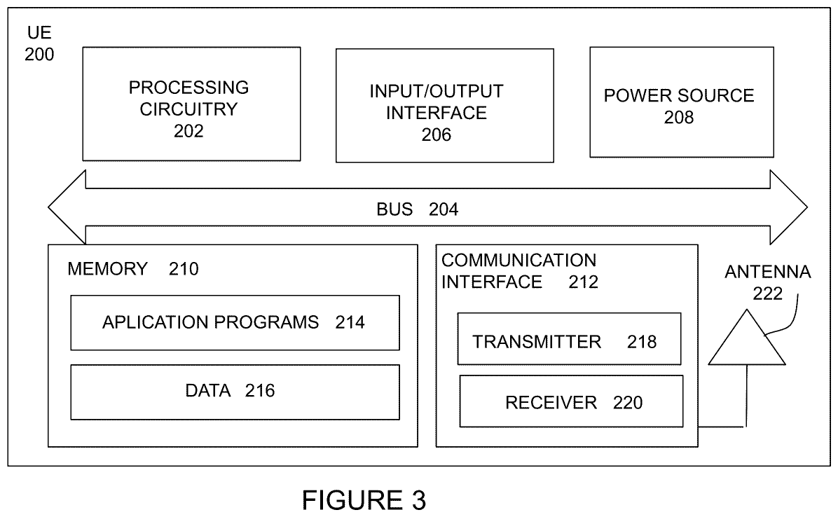

FIG. 3 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 3. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 3.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

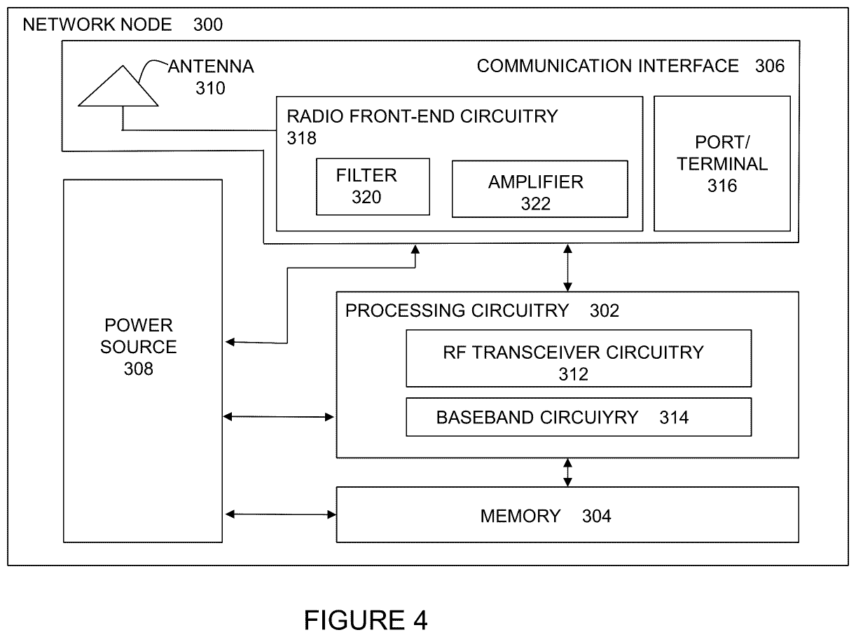

FIG. 4 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), OAM nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 4 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

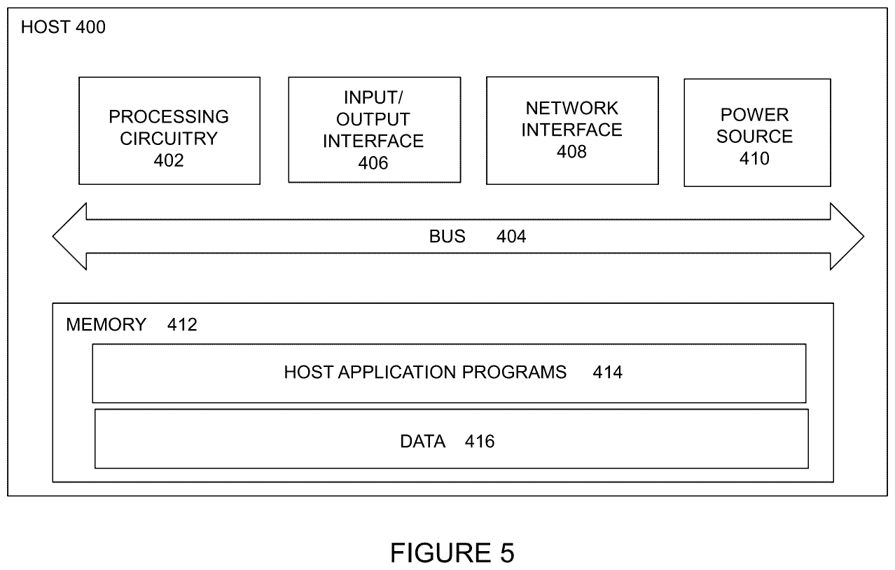

FIG. 5 is a block diagram of a host 400, which may be an embodiment of the host 116 of FIG. 2, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

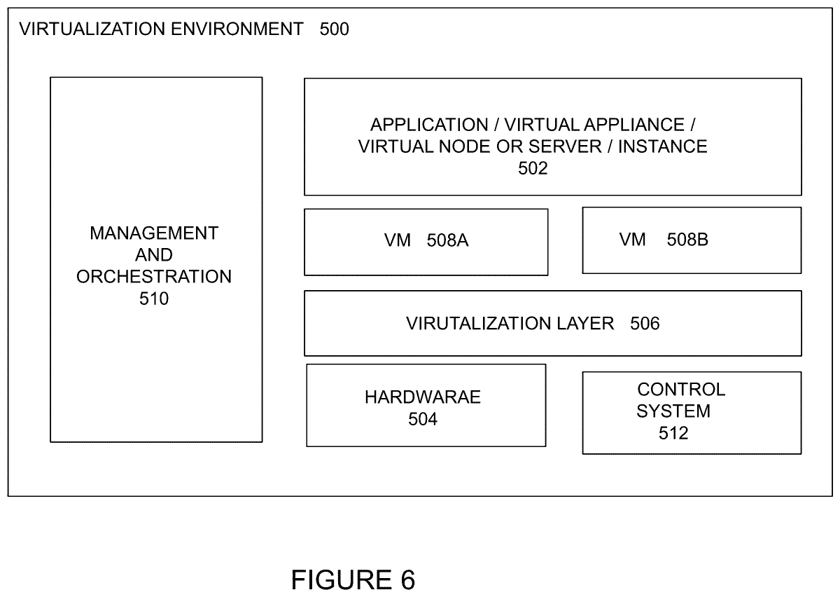

FIG. 6 is a block diagram illustrating a virtualization environment 500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment 500 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

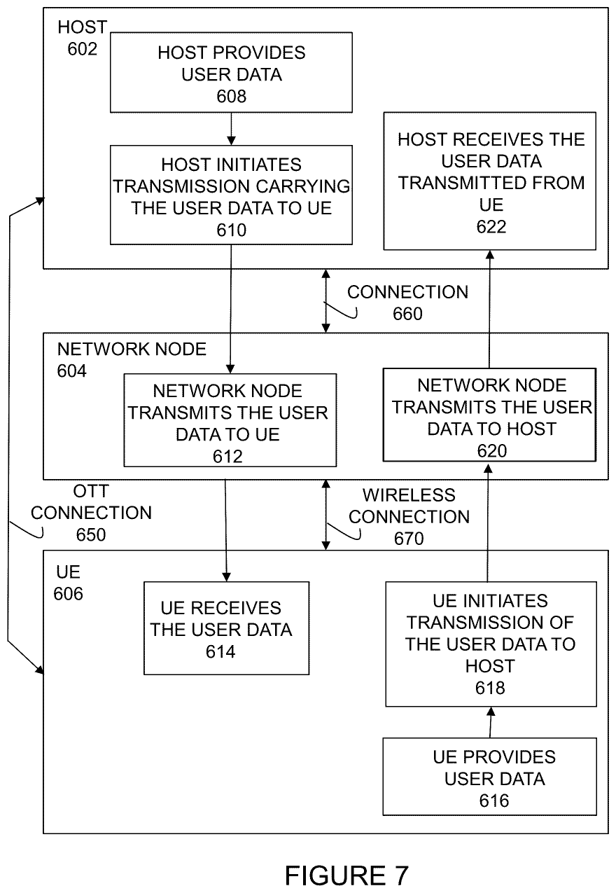

FIG. 7 shows a communication diagram of a host 602 communicating via a network node 604 with a UE 606 over a partially wireless connection in accordance with some embodiments.

Example implementations, in accordance with various embodiments, of the UE (such as a UE 112a of FIG. 2 and/or UE 200 of FIG. 3), network node (such as network node 110a of FIG. 2 and/or network node 300 of FIG. 4), and host (such as host 116 of FIG. 2 and/or host 400 of FIG. 5) discussed in the preceding paragraphs will now be described with reference to FIG. 7.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 2) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

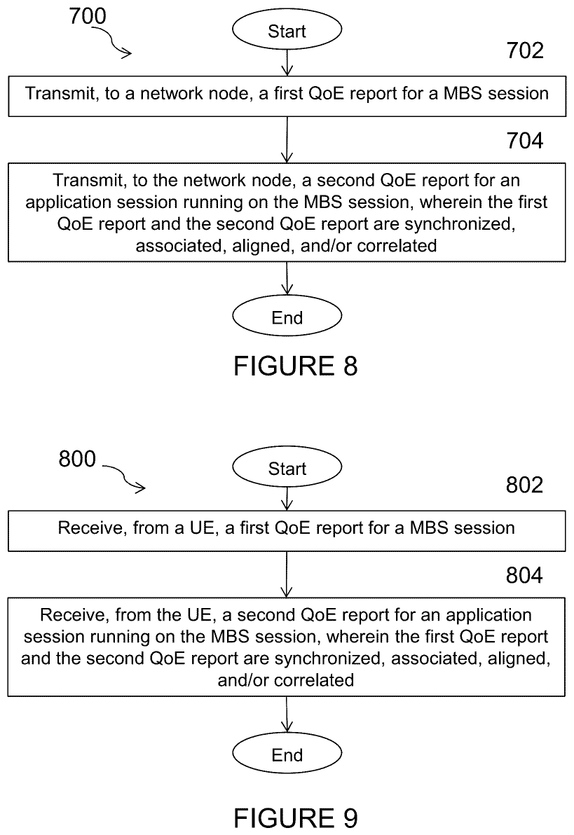

FIG. 8 illustrates a method 700 by a UE 112 for an alignment of QoE for service types, according to certain embodiments. The method includes, at step 702, the UE 112 transmitting, to a network node 110, a first QoE report for a MBS session. At step 704, the UE 112 transmits, to the network node 110, a second QoE report for an application session running on the MBS session. The first QoE report and the second QoE report are synchronized, associated, aligned, and/or correlated.

In a particular embodiment, the UE 112 transmits, to the network node 110, information indicating a synchronization, association, alignment, and/or correlation between the first QoE report and the second QoE report.

In a further particular embodiment, the information comprises a reference in the first QoE report to the second QoE report. Additionally or alternatively, the information comprises a reference in the second QoE report to the first QoE report.

In a further particular embodiment, the information includes a reference that is associated with at least one of the first QoE report and the second QoE report. The reference indicates the synchronization, association, alignment and/or correlation between the first QoE report and the second QoE report.

In a further particular embodiment, the reference comprises at least one of: a legacy QoE reference; a new QoE reference a recording session identifier; and a measConfigAppLayerID.

In a further particular embodiment, the information comprises timing information associated with at least one of the first QoE report and the second QoE report.

In a further particular embodiment, the timing information comprises one or more of: a first time stamp associated with a start time of at least one first QoE measurement performed for the MBS session; a second time associated with an end time of at least one first QoE measurement performed for the MBS session; a third time stamp associated with a start time of at least one second QoE measurement performed for the application session; and a fourth time stamp associated with an end time of at least one second QoE measurement performed for the application session.

In a further particular embodiment, the first QoE report and the second QoE report are transmitted in a single message, and the association, alignment, and/or correlation between the first QoE report and the second QoE report is inherently indicated based on the first QoE report and the second QoE report being in the single message.

In a particular embodiment, the first QoE report and the second QoE report are transmitted in a single message, and wherein the single message comprises an indication of the association, alignment, and/or correlation between the first QoE report and the second QoE report.

In a particular embodiment, the first QoE report comprises at least one value associated with at least one first QoE measurement performed for the MBS session. The second QoE report comprises at least one value associated with at least one second QoE measurement performed for the application session, and the at least one first QoE measurement and the at least one second QoE measurement are associated, aligned, and/or correlated.

In a further particular embodiment, a start time of the at least one first QoE measurement is synchronized, associated, aligned, and/or correlated with a start time of the at least one second QoE measurement. Additionally or alternatively, an end time of the at least one first QoE measurement is synchronized, associated, aligned, and/or correlated with an end time of the at least one second QoE measurement.

In a particular embodiment, the UE 112 performs the at least one first QoE measurement for the MBS session and generating the first QoE report based on the at least one first QoE measurement. The UE performs the at least one second QoE measurement for the application session and generating the second QoE report based on the at least one second QoE measurement.

In a particular embodiment, the at least one first QoE measurement and the at least one second QoE measurement are performed simultaneously.

In a particular embodiment, the UE 112 determines that a triggering condition has been fulfilled and initiates the at least one first QoE measurement and the at least one second QoE measurement in response to the triggering condition being fulfilled.

In a particular embodiment, the UE 112 initiates the at least one second QoE measurement for the application session when the at least one first QoE measurement for the MBS session is initiated.

In a particular embodiment, the UE 112 generates, by an MBS entity, an indication when the at least one first QoE measurement for the MBS session is initiated. The UE 112 transmits the indication from the MBS entity to the application to trigger the application to initiate the at least one second QoE measurement for the application session.

In a particular embodiment, the UE 112 initiates the at least one first QoE measurement for the MBS session when the at least one second QoE measurement for the application session is initiated.

In a further particular embodiment, the UE 112 generates, by the application, an indication when the at least one second QoE measurement for the application session is initiated. The UE 112 transmits the indication from the application to an MBS entity to trigger the MBS entity to initiate the at least one first QoE measurement for the MBS session.

In a further particular embodiment, the indication is transmitted from the application to the MBS entity or from the MBS entity to the application via a UE AS.

In a particular embodiment, the indication is transmitted from the application to the MBS entity or from the MBS entity to the application via a RAN network node.

In a further particular embodiment, the MBS entity is at an AS of the UE or the MBS entity is at an application layer of the UE.

In a particular embodiment, the UE 112 receives, from the network node 110, a first QoE measurement configuration associated with the MBS session. A MBS measurement session includes the at least one first QoE measurement is performed for the MBS session based on the first QoE measurement configuration. The UE 112 receives, from the network node 110, a second QoE measurement configuration associated with the application session. An application measurement session includes the at least one second QoE measurement is performed for the application session based on the second QoE measurement configuration.

FIG. 9 illustrates a method 800 by a network node 110 for an alignment of QoE for service types, according to certain embodiments. The method begins at step 802 when the network node 110 receives, from a UE 112, a first QoE report for a MBS session. At step 804, the network node 110 receives, from the UE 112, a second QoE report for an application session running on the MBS session. The first QoE report and the second QoE report are synchronized, associated, aligned, and/or correlated.

In a particular embodiment, the network node 110 determines an impact of a MBS transmission associated with the MBS session on a QoE of the application session and/or determines an impact of the application session on a QoE of the MBS session.

In a particular embodiment, the network node 110 receives, from the UE 112, information indicating a synchronization, association, alignment and/or correlation between the first QoE report and the second QoE report.

In a particular embodiment, the information comprises a reference in the first QoE report to the second QoE report and/or the information comprises a reference in the second QoE report to the first QoE report.

In a particular embodiment, the information includes a reference that is associated with at least one of the first QoE report and the second QoE report, and the reference indicates the synchronization, association, alignment and/or correlation between the first QoE report and the second QoE report.

In a particular embodiment, the reference includes at least one of: a legacy QoE reference; a new QoE reference a recording session identifier; and a measConfigAppLayerID.

In a particular embodiment, the information comprises timing information associated with at least one of the first QoE report and the second QoE report.

In a further particular embodiment, the timing information comprises one or more of: a first time stamp associated with a start time of at least one first QoE measurement performed for the MBS session; a second time associated with an end time of at least one first QoE measurement performed for the MBS session; a third time stamp associated with a start time of at least one second QoE measurement performed for the application session; and a fourth time stamp associated with an end time of at least one second QoE measurement performed for the application session.

In a particular embodiment, the first QoE report and the second QoE report are received in a single message, and the network node 110 determines an association, alignment, and/or correlation between the first QoE report and the second QoE report based on the first QoE report and the second QoE report being in the single message.

In a particular embodiment, the first QoE report comprises at least one value associated with at least one first QoE measurement performed for the MBS session, and the second QoE report comprises at least one value associated with at least one second QoE measurement performed for the application session. The at least one first QoE measurement and the at least one second QoE measurement are associated, aligned, and/or correlated.

In a further particular embodiment, a start time of the at least one first QoE measurement is associated, aligned, and/or correlated with a start time of the at least one second QoE measurement. Additionally or alternatively, an end time of the at least one first QoE measurement is associated, aligned, and/or correlated with an end time of the at least one second QoE measurement.

In a particular embodiment, the network node 110 configures the UE 112 to initiate the at least one first QoE measurement for the MBS session when the at least one second QoE measurement for the application session is initiated.

In a particular embodiment, the network node 110 configures the UE 112 to generate, by the application, an indication when the at least one second QoE measurement for the application session is initiated and transmit the indication from the application to an MBS entity to trigger the MBS entity to initiate the at least one first QoE measurement for the MBS session.

In a particular embodiment, the network node 110 configures the UE 112 to transmit the indication from the application to the MBS entity or from the MBS entity to the application via an UE AS.

In a particular embodiment, the network node 110 transmits, to the UE 112, a first QoE measurement configuration associated with the MBS session. A MBS measurement session includes the at least one first QoE measurement is performed for the MBS session based on the first QoE measurement configuration. The network node 110 transmits to the UE 112, a second QoE measurement configuration associated with the application session. An application measurement session comprising the at least one second QoE measurement is performed for the application session based on the second QoE measurement configuration.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Example Embodiments

### Group A Example Embodiments

Example Embodiment A1. A method by a user equipment for an alignment of Quality of Experience (QoE) for an application and QoE for a Multicast and Broadcast Services (MBS), the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for an alignment of Quality of Experience (QoE) for an application and QoE for a Multicast and Broadcast Services (MBS), the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for an alignment of Quality of Experience (QoE) for service types, the method comprising: transmitting, to a network node, a first QoE report for a Multicast and Broadcast Services (MBS) session; transmitting, to the network node, a second QoE report for an application session running on the MBS session, and wherein the first QoE report and the second QoE report are associated, aligned, and or correlated.

Example Embodiment C2. The method of Example Embodiment C1, comprising maintaining an association, alignment, and/or correlation between the first QoE report and the second QoE report.

Example Embodiment C3. The method of Example Embodiment C2, comprising transmitting, to the network node, information indicating the association, alignment and/or correlation between the first QoE report and the second QoE report.

Example Embodiment C4. The method of Example Embodiment C3, wherein the information comprises a reference in the first QoE report to the second QoE report.

Example Embodiment C5. The method of Example Embodiment C3, wherein the information comprises a reference in the second QoE report to the first QoE report.

Example Embodiment C6. The method of Example Embodiment C3, wherein the information comprises a reference that is associated with at least one of the first QoE report and the second QoE report, wherein the reference indicates the association, alignment and/or correlation between the first QoE report and the second QoE report.

Example Embodiment C7. The method of Example Embodiment C6, wherein the reference comprises at least one of: a legacy QoE reference; a new QoE reference; a recording session identifier; and a measConfigAppLayerID.

Example Embodiment C8. The method of Example Embodiment C3, wherein the information comprises timing information associated with at least one of the first QoE report and the second QoE report.

Example Embodiment C9. The method of Example Embodiment C8, wherein the timing information comprises one or more of: a first time stamp associated with a start time of at least one first QoE measurement performed for the MBS session; a second time associated with an end time of at least one first QoE measurement performed for the MBS session; a third time stamp associated with a start time of at least one second QoE measurement performed for the application session; and a fourth time stamp associated with an end time of at least one second QoE measurement performed for the application session.

Example Embodiment C10. The method of Example Embodiment C1, wherein the first QoE report and the second QoE report are transmitted in a single message, and wherein the association, alignment, and/or correlation between the first QoE report and the second QoE report is inherently indicated based on the first QoE report and the second QoE report being in the single message.

Example Embodiment C11. The method of Example Embodiment C1, wherein the first QoE report and the second QoE report are transmitted in a single message, and wherein the single message comprises an indication of the association, alignment, and/or correlation between the first QoE report and the second QoE report.

Example Embodiment C12. The method of any one of Example Embodiments C1 to C11, wherein: the first QoE report comprises at least one value associated with at least one first QoE measurement performed for the MBS session, and the second QoE report comprises at least one value associated with at least one second QoE measurement performed for the application session, and wherein the at least one first QoE measurement and the at least one second QoE measurement are associated, aligned, and/or correlated.

Example Embodiment C13. The method of Example Embodiment C12, wherein a start time of the at least one first QoE measurement is associated, aligned, and/or correlated with a start time of the at least one second QoE measurement.

Example Embodiment C14. The method of any one of Example Embodiments C12 to C13, wherein an end time of the at least one first QoE measurement is associated, aligned, and/or correlated with an end time of the at least one second QoE measurement.

Example Embodiment C15. The method of any one of Example Embodiments C12 to C14, comprising: performing the at least one first QoE measurement for the MBS session and generating the first QoE report based on the at least one first QoE measurement; and performing at least one second QoE measurement for the application session and generating the second QoE report based on the at least one second QoE measurement.

Example Embodiment C16. The method of any one of Example Embodiments C12 to C15, wherein the at least one first QoE measurement and the at least one second QoE measurement are performed simultaneously.

Example Embodiment C17. The method of any one of Example Embodiments C12 to C15, comprising determining that a triggering condition has been fulfilled and initiating the at least one first QoE measurement and the at least one second QoE measurement in response to the triggering condition being fulfilled.

Example Embodiment C18. The method of any one of Example Embodiments C12 to C15, comprising initiating the at least one second QoE measurement for the application session when the at least one first QoE measurement for the MBS session is initiated.

Example Embodiment C19. The method of Example Embodiment C18, comprising: generating, by an MBS entity, an indication when the at least one first QoE measurement for the MBS session is initiated, and transmitting the indication from the MBS entity to the application to trigger the application to initiate the at least one second QoE measurement for the application session.

Example Embodiment C20. The method of any one of Example Embodiments C12 to C15, comprising initiating the at least one first QoE measurement for the MBS session when the at least one second QoE measurement for the application session is initiated.

Example Embodiment C21. The method of Example Embodiment C201, comprising:
generating, by the application, an indication when the at least one second QoE measurement for the application session is initiated, and transmitting the indication from the application to an MBS entity to trigger the MBS entity to initiate the at least one first QoE measurement for the MBS session.

Example Embodiment C22. The method of any one of Example Embodiments C16 to C21, wherein the indication is transmitted from the application to the MBS entity or from the MBS entity to the application via an UE AS.

Example Embodiment C23. The method of any one of Example Embodiments C16 to C21, wherein the indication is transmitted from the application to the MBS entity or from the MBS entity to the application via a RAN network node.

Example Embodiment C24. The method of any one of Example Embodiments C16 to C23, wherein the MBS entity is at an application layer of the UE.

Example Embodiment C25. The method of any one of Example Embodiments C1 to C24, comprising: receiving, from the network node, a first QoE measurement configuration associated with the MBS session, wherein a MBS measurement session comprising the at least one first QoE measurement is performed for the MBS session based on the first QoE measurement configuration; and receiving, from the network node, a second QoE measurement configuration associated with the application session, wherein an application measurement session comprising the at least one second QoE measurement is performed for the application session based on the second QoE measurement configuration.

Example Embodiment C26. The method of Example Embodiments C1 to C25, further comprising: providing user data; and forwarding the user data to a host via the transmission to the network node.

Example Embodiment C27. A user equipment comprising processing circuitry configured to perform any of the methods of Example Embodiments C1 to C26.

Example Embodiment C28. A user equipment configured to perform any of the methods of Example Embodiments C1 to C26.

Example Embodiment C29. A wireless device comprising processing circuitry configured to perform any of the methods of Example Embodiments C1 to C26.

Example Embodiment C30. A computer program comprising instructions which when executed on a computer perform any of the methods of Example Embodiments C1 to C26.

Example Embodiment C31. A computer program product comprising computer program, the computer program comprising instructions which when executed on a computer perform any of the methods of Example Embodiments C to C26.

Example Embodiment C32. A non-transitory computer readable medium storing instructions which when executed by a computer perform any of the methods of Example Embodiments C1 to C26.

### Group D Example Embodiments

Example Embodiment D1. A method by a network node for an alignment of Quality of Experience (QoE) for service types, the method comprising: receiving, from a user equipment (UE), a first QoE report for a Multicast and Broadcast Services (MBS) session; receiving, from the UE, a second QoE report for an application session running on the MBS session, and wherein the first QoE report and the second QoE report are associated, aligned, and or correlated.

Example Embodiment D2. The method of Example Embodiment D1, comprising at least one of: determining an impact of a MBS transmission associated with the MBS session on a QoE of the application session; and determining an impact of the application session on a QoE of the

Example Embodiment D3. The method of any one of Example Embodiments D1 to D2, comprising receiving, from the UE, information indicating an association, alignment and/or correlation between the first QoE report and the second QoE report.

Example Embodiment D4. The method of Example Embodiment D3, wherein the information comprises a reference in the first QoE report to the second QoE report. MBS session.

Example Embodiment D5. The method of Example Embodiment D3, wherein the information comprises a reference in the second QoE report to the first QoE report.

Example Embodiment D6. The method of Example Embodiment D3, wherein the information comprises a reference that is associated with at least one of the first QoE report and the second QoE report, wherein the reference indicates the association, alignment and/or correlation between the first QoE report and the second QoE report.

Example Embodiment D7. The method of Example Embodiment D6, wherein the reference comprises at least one of: a legacy QoE reference; a new QoE reference; a recording session identifier; and a measConfigAppLayerID.

Example Embodiment D8. The method of Example Embodiment D3, wherein the information comprises timing information associated with at least one of the first QoE report and the second QoE report.

Example Embodiment D9. The method of Example Embodiment D8, wherein the timing information comprises one or more of: a first time stamp associated with a start time of at least one first QoE measurement performed for the MBS session; a second time associated with an end time of at least one first QoE measurement performed for the MBS session; a third time stamp associated with a start time of at least one second QoE measurement performed for the application session; and a fourth time stamp associated with an end time of at least one second QoE measurement performed for the application session.

Example Embodiment D10. The method of any one of Example Embodiments D1 to D2, wherein the first QoE report and the second QoE report are received in a single message, and the method comprises determining an association, alignment, and/or correlation between the first QoE report and the second QoE report based on the first QoE report and the second QoE report being in the single message.

Example Embodiment D11. The method of any one of Example Embodiments D1 to D2, wherein the first QoE report and the second QoE report are received in a single message, and wherein the single message comprises an indication of the association, alignment, and/or correlation between the first QoE report and the second QoE report.

Example Embodiment D12. The method of any one of Example Embodiments D1 to D11, wherein: the first QoE report comprises at least one value associated with at least one first QoE measurement performed for the MBS session, and the second QoE report comprises at least one value associated with at least one second QoE measurement performed for the application session, and wherein the at least one first QoE measurement and the at least one second QoE measurement are associated, aligned, and/or correlated.

Example Embodiment D13. The method of Example Embodiment D12, wherein a start time of the at least one first QoE measurement is associated, aligned, and/or correlated with a start time of the at least one second QoE measurement.

Example Embodiment D14. The method of any one of Example Embodiments D12 to D13, wherein an end time of the at least one first QoE measurement is associated, aligned, and/or correlated with an end time of the at least one second QoE measurement.

Example Embodiment D15. The method of any one of Example Embodiments D12 to D14, comprising configuring the UE to: perform the at least one first QoE measurement for the MBS session and generate the first QoE report based on the at least one first QoE measurement; and perform at least one second QoE measurement for the application session and generate the second QoE report based on the at least one second QoE measurement.

Example Embodiment D16. The method of any one of Example Embodiments D12 to D15, comprising configuring the UE to perform the at least one first QoE measurement and the at least one second QoE measurement simultaneously.

Example Embodiment D17. The method of any one of Example Embodiments D12 to D15, comprising configuring the UE to determine that a triggering condition has been fulfilled and initiate the at least one first QoE measurement and the at least one second QoE measurement in response to the triggering condition being fulfilled.

Example Embodiment D18. The method of any one of Example Embodiments D12 to D15, comprising configuring the UE to initiate the at least one second QoE measurement for the application session when the at least one first QoE measurement for the MBS session is initiated.

Example Embodiment D19. The method of Example Embodiment D18, configuring the UE to: generate, by an MBS entity, an indication when the at least one first QoE measurement for the MBS session is initiated, and transmit the indication from the MBS entity to the application to trigger the application to initiate the at least one second QoE measurement for the application session.

Example Embodiment D20. The method of any one of Example Embodiments D12 to D15, comprising configuring the UE to initiate the at least one first QoE measurement for the MBS session when the at least one second QoE measurement for the application session is initiated.

Example Embodiment D21. The method of Example Embodiment D20, comprising configuring the UE to: generate, by the application, an indication when the at least one second QoE measurement for the application session is initiated, and transmit the indication from the application to an MBS entity to trigger the MBS entity to initiate the at least one first QoE measurement for the MBS session.

Example Embodiment D22. The method of any one of Example Embodiments D16 to D21, comprising configuring the UE to transmit the indication from the application to the MBS entity or from the MBS entity to the application via an UE AS.

Example Embodiment D23. The method of any one of Example Embodiments D16 to D21, comprising: receiving, at the network node, the indication from the application and transmitting the indication to the MBS entity; or receiving, at the network node, the indication from the MBS entity and transmitting the indication to the application.

Example Embodiment D24. The method of any one of Example Embodiments D16 to D23, wherein the MBS entity is at an application layer of the UE.

Example Embodiment D25. The method of any one of Example Embodiments D1 to D24, comprising: transmitting, to the UE, a first QoE measurement configuration associated with the MBS session, and wherein a MBS measurement session comprising the at least one first QoE measurement is performed for the MBS session based on the first QoE measurement configuration; and transmitting to the UE, a second QoE measurement configuration associated with the application session, and wherein an application measurement session comprising the at least one second QoE measurement is performed for the application session based on the second QoE measurement configuration.

Example Embodiment D26. The method of any one of Example Embodiments D1 to D25, wherein the network node comprises a gNodeB (gNB).

Example Embodiment D27. The method of any of the previous Example Embodiments, further comprising: obtaining user data; and forwarding the user data to a host or a user equipment.

Example Embodiment D28. A network node comprising processing circuitry configured to perform any of the methods of Example Embodiments D1 to D27.

Example Embodiment D29. A computer program comprising instructions which when executed on a computer perform any of the methods of Example Embodiments D1 to D27.

Example Embodiment D30. A computer program product comprising computer program, the computer program comprising instructions which when executed on a computer perform any of the methods of Example Embodiments D1 to D27.

Example Embodiment D31. A non-transitory computer readable medium storing instructions which when executed by a computer perform any of the methods of Example Embodiments D1 to D27.

### Group E Example Embodiments

Example Embodiment E1. A user equipment (UE) for an alignment of Quality of Experience (QoE) for service types, the UE comprising: processing circuitry configured to perform any of the steps of any of the Group A and C Example Embodiments; and power supply circuitry configured to supply power to the processing circuitry.

Example Embodiment E2. A network node for an alignment of Quality of Experience (QoE) for service types, the network node comprising: processing circuitry configured to perform any of the steps of any of the Group B and D Example Embodiments; power supply circuitry configured to supply power to the processing circuitry.

Example Embodiment E3. A user equipment (UE) for an alignment of Quality of Experience (QoE) for service types, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C

Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1. A method by a user equipment, UE, for an alignment of Quality of Experience, QoE, for service types, the method comprising:
transmitting, to a network node, a first QoE report for a Multicast and Broadcast Services, MBS, session;
transmitting, to the network node, a second QoE report for an application session running on the MBS session, and
wherein the first QoE report and the second QoE report are synchronized, associated, aligned, and/or correlated.

2. The method of claim 1, comprising transmitting, to the network node, information indicating a synchronization, association, alignment, and/or correlation between the first QoE report and the second QoE report.

3. The method of claim 2, wherein at least one of:
the information comprises a reference in the first QoE report to the second QoE report, and the information comprises a reference in the second QoE report to the first QoE report.

4. The method of claim 2, wherein the information comprises a reference that is associated with at least one of the first QoE report and the second QoE report, wherein the reference indicates the synchronization, association, alignment and/or correlation between the first QoE report and the second QoE report.

5. The method of claim 4, wherein the reference comprises at least one of:
a legacy QoE reference;
a new QoE reference a recording session identifier; and
a measConfigAppLayerID.

6. The method of claim 2, wherein the information comprises timing information associated with at least one of the first QoE report and the second QoE report.

7. The method of claim 6, wherein the timing information comprises one or more of:
a first time stamp associated with a start time of at least one first QoE measurement performed for the MBS session;
a second time associated with an end time of at least one first QoE measurement performed for the MBS session;
a third time stamp associated with a start time of at least one second QoE measurement performed for the application session; and
a fourth time stamp associated with an end time of at least one second QoE measurement performed for the application session.

8. The method of claim 1, wherein the first QoE report and the second QoE report are transmitted in a single message, and wherein the association, alignment, and/or correlation between the first QoE report and the second QoE report is inherently indicated based on the first QoE report and the second QoE report being in the single message.

9. The method of claim 1, wherein:
the first QoE report comprises at least one value associated with at least one first QoE measurement performed for the MBS session, and
the second QoE report comprises at least one value associated with at least one second QoE measurement performed for the application session, and
wherein the at least one first QoE measurement and the at least one second QoE measurement are associated, aligned, and/or correlated.

10. The method of claim 9, wherein at least one of:
a start time of the at least one first QoE measurement is synchronized, associated, aligned, and/or correlated with a start time of the at least one second QoE measurement, and
an end time of the at least one first QoE measurement is synchronized, associated, aligned, and/or correlated with an end time of the at least one second QoE measurement.

11. The method of claim 9, comprising:
performing the at least one first QoE measurement for the MBS session and generating the first QoE report based on the at least one first QoE measurement; and
performing the at least one second QoE measurement for the application session and generating the second QoE report based on the at least one second QoE measurement.

12. The method of claim 9, wherein the at least one first QoE measurement and the at least one second QoE measurement are performed simultaneously.

13. The method of claim 9, comprising determining that a triggering condition has been fulfilled and initiating the at least one first QoE measurement and the at least one second QoE measurement in response to the triggering condition being fulfilled.

14. The method of claim 9, comprising initiating the at least one second QoE measurement for the application session when the at least one first QoE measurement for the MBS session is initiated.

15. The method of claim 14, comprising:
generating, by an MBS entity, an indication when the at least one first QoE measurement for the MBS session is initiated, and
transmitting the indication from the MBS entity to the application to trigger the application to initiate the at least one second QoE measurement for the application session.

16. The method of claim 9, comprising initiating the at least one first QoE measurement for the MBS session when the at least one second QoE measurement for the application session is initiated.

17. The method of claim 16, comprising:
generating, by the application, an indication when the at least one second QoE measurement for the application session is initiated, and
transmitting the indication from the application to an MBS entity to trigger the MBS entity to initiate the at least one first QoE measurement for the MBS session.

18. The method of claim 15, wherein the indication is transmitted from the application to the MBS entity or from the MBS entity to the application via a UE Access Stratum, AS.

19. The method of claim 1, comprising:
receiving, from the network node, a first QoE measurement configuration associated with the MBS session, wherein a MBS measurement session comprising the at least one first QoE measurement is performed for the MBS session based on the first QoE measurement configuration; and
receiving, from the network node, a second QoE measurement configuration associated with the application session, wherein an application measurement session comprising the at least one second QoE measurement is performed for the application session based on the second QoE measurement configuration.

20. A method by a network node for an alignment of Quality of Experience, QoE, for service types, the method comprising:
receiving, from a user equipment, UE, a first QoE report for a Multicast and Broadcast Services, MBS, session;
receiving, from the UE, a second QoE report for an application session running on the MBS session, and
wherein the first QoE report and the second QoE report are synchronized, associated, aligned, and/or correlated.

21. The method of claim 20, comprising at least one of:
determining an impact of a MBS transmission associated with the MBS session on a QoE of the application session; and
determining an impact of the application session on a QoE of the MBS session.

22. The method of claim 20, comprising receiving, from the UE, information indicating a synchronization, association, alignment and/or correlation between the first QoE report and the second QoE report.

23. The method of claim 22, wherein at least one of:
the information comprises a reference in the first QoE report to the second QoE report, and
the information comprises a reference in the second QoE report to the first QoE report.

24. The method of claim 22, wherein the information comprises a reference that is associated with at least one of the first QoE report and the second QoE report, wherein the reference indicates the synchronization, association, alignment and/or correlation between the first QoE report and the second QoE report.

25. (canceled)

26. (canceled)

27. (canceled)

28. (canceled)

29. (canceled)

31. (canceled)

32. (canceled)

33. (canceled)

34. (canceled)

35. A user equipment, UE, for an alignment of Quality of Experience, QoE for service types, the UE configured to:
transmit, to a network node, a first QoE report for a Multicast and Broadcast Services, MBS, session; and
transmit, to the network node, a second QoE report for an application session running on the MBS session, and
wherein the first QoE report and the second QoE report are associated, aligned, and/or correlated.

36. (canceled)

37. A network node for an alignment of Quality of Experience, QoE, for service types, the network node configured to:
receive, from a user equipment, UE, a first QoE report for a Multicast and Broadcast Services, MBS, session; and
receive, from the UE, a second QoE report for an application session running on the MBS session, and
wherein the first QoE report and the second QoE report are associated, aligned, and or correlated.

38. (canceled)
